(19) United States
(12) Patent Application Publication
(10) Pub. No.: US 2005/0227870 A1
(43) Pub. Date: Oct. 13, 2005

(54) Method to kill kudzu

(76) Inventor: Floyd C. Cotney, Roswell, GA (US)

Correspondence Address: GEORGE R. REARDON, 3356 STATION COURT, LAWRENCVILLE, GA, 30044, US

(21) Appl. No.: 10/819,679

(22) Filed: Apr. 7, 2004

(51) Int. Cl. A01N 25/00

(52) U.S. Cl. 504/117; 47/58.1 R

(57) ABSTRACT

Methods for killing kudzu are provided that use the inducement of apoptosis in kudzu in a controlled environment to isolate and synthesize a substance that can be applied to kudzu plants in the field in order to trigger cell suicide in the roots of the kudzu plants.

### BACKGROUND OF THE INVENTION

This invention relates to a system and method for killing kudzu. Specifically, this invention relates to killing kudzu by using an aspect of programmed cell death (PCD) in plant biology known as apoptosis.

Kudzu is a deep-rooted, super-fast-growing vine that overruns land disturbed by construction or agriculture, especially in the United States, at the rate of a foot a day. Originating from China and native to Japan, kudzu was introduced to the United States in 1876 at the Centennial Exposition in Philadelphia. During the Great Depression, the U.S. Soil Conservation Service promoted kudzu as a means of erosion control. In 1953, the U.S. government stopped advocating its use. The so-called “miracle vine” grew and spread too fast because it was imported without its natural predators. In 1972, the Department of Agriculture officially declared kudzu a weed. Under ideal weather conditions, a temperate, moderately wet climate, as typically found in the Southeast, kudzu overtakes most everything in its path, in the process harming forests by shielding light from trees and distorting the landscape with its accumulated weight.

While some people use kudzu for ornamental purposes, and others for medical treatment or cosmetics, for Southern farmers, landscapers and common citizens, it is a major problem—one that is quite literally taking over their land. Attempts to control or eradicate Kudzu include burning, bulldozing, herbicides, chemicals such as Vine-X, fungus mixed with herbicides and insects.

Apoptosis is derived from a Greek word and means “the falling off of petals from a flower”. Apoptosis is an evolutionarily conserved, very ordered process that selectively and quickly removes damaged, excess, or aged cells. It plays an important part in embryonic development, metamorphosis, and morphogenesis in both plants and animals. Apoptosis also can be invoked as a suicide program in which the cell directs its own death after the appearance or disappearance of many different signals. Multiple distinct signaling pathways are involved in the induction of apoptosis.

Apoptosis is directed by an ordered set of biochemical steps that result in distinct morphological changes in the cell, which are measurable. Some morphological changes that occur include fragmentation of the cell's DNA, aggregation of the nuclear material in discrete patches, condensation of the chromatin, and degradation of the prominent vacuole. Apoptosis is very rapid. Once initiated within the cell, the apoptosis process is essentially irreversible.

The induction of apoptosis in plants generally follows one of two major biochemical pathways—intrinsic or extrinsic. The intrinsic pathway occurs when the cell is deprived of certain survival factors or exposed to external toxins, intracellular damage, or stress signals. The intrinsic pathway represents a middle ground in the amount of cumulative stress affecting the cells. To initiate apoptosis the stress should be more than the cell can handle and recover from but insufficient to kill the cell outright by necrosis.

There has also been notable work done on plant apoptosis utilizing the soybean, which belongs to the legume family. It has been shown that the apoptosis in soybeans occurs primarily in the root and root caps of the plant. The kudzu plant is likewise a member of the legume family and characteristically has an extensive root system with a large main root.

In response to a pathogen attack, the cells of a plant will often accumulate high concentrations of toxic phenolic compounds at the site of the infection, die, and encircle the pathogen in a circular island of death. This island of death is termed a necrotic lesion. The purpose of the necrotic lesion is to surround the pathogen in a toxic nutritionally depleted environment, effectively isolating it, and preventing it from spreading to surrounding healthy tissues. This rapid localized cell death due to a pathogen is called the hypersensitive response. Originally thought to be a simple case of necrosis or cell death caused by poisons or other external factors, the hypersensitive response is now recognized as another example of PCD. In this case, the pathogen releases signals that initiate biochemical pathways that cause the cells to commit suicide. The hypersensitive response is a genetically programmed process rather than simple necrosis.

Apoptosis is linked with the plant's hypersensitive response which employs isolated auto-produced toxins within the “island of death” or necrotic lesion to kill pathogens. This toxin must be isolated by the sacrificed dead cells to protect the rest of the plant. Additionally, some research in developing maize has shown that a burst of ethylene synthesis was observed prior to the onset of PCD at certain stages of developmental transformation. Nuclease activation and progression of DNA degradation was regulated by the level of ethylene production. Ethylene is a plant hormone that is 300 times more toxic to plants than carbon monoxide is to humans a signal that propagates cell death in a tissue in contrast to downstream signaling events within a cell that carry out cell death after receiving an appropriate trigger such as ethylene.

Other attempts to isolate substances that kill weeds such as kudzu include the research on knapweed. Knapweed roots secrete the chemical catechin which triggers the production of free radicals in the roots of other plants, which passes upward, activating a wave of cell death. In essence, a tiny amount of catechin induces other plants to commit suicide.

Additionally, research has been conducted on the bio-herbicidal fungus Myrothecium verrucaria. This fungus has been applied to kudzu, Pueraria Montana, in combination with glyphosate to test for synergistic interactions. Kudzu weeds were controlled 96%, 86% and 78%, respectively, in field sites that were infested with kudzu, by simultaneous applications of glyphosate and corn oil emulsion formulations. Electron microscopy revealed an apparent mechanism of action with the pathogenesis process of this fungus infecting the exotic invasive weed kudzu. Nearly immediately after applying the fungus, kudzu cells were found to detach the plasmamenbrane from the surrounding cell wall, which breaks off cell connections, resulting in leaf flaccidity, followed by rapid necrosis and mortality. These findings indicate that a compound produced by the fungus rather than the fungus itself causes the dramatic changes in the plasmamembrane-cell connections and quickly leads to cell death.

Other research shows that Ca²⁺ enhances the apoptosis process while Zn²⁺ inhibits the process. Still other research shows that signal transduction pathways lead to cell death by specifically ordered metabolic changes during normal development, environmental stress, or pathogen attack.

Known prior art includes the following. U.S. Pat. Nos. 6,063,580 and 5,939,267, both issued to Maiese, which relate to methods for determining the induction and assessing the course of programmed cell death (PCD) over time in living cells. U.S. Pat. No. 6,693,185, issued to Babiychuk, which relates to the use of isolated polynucleotides encoding maize poly (ADP-ribose) polymerase (PARP) proteins to produce eukaryotic cells and organisms, particularly plant cells and plants, with modified programmed cell death. U.S. Pat. No. 6,310,273 issued to Gilchrist relates to methods and means to modulate programmed cell death in eukaryotic cells, specifically, apoptosis in plants using a baculovirus p35 protease inhibitor gene. U.S. Pat. No. 6,570,069, issued to Hammock, relates to nucleic acids encoding plant inhibitors of apoptosis and transgenic cells and plants expressing them. U.S. Pat. No. 6,162,965 issued to Hansen, relates to plant transformation methods.

While these patents and other previous methods have made an effort toward observing, regulating or inhibiting apoptosis, none have provided for inducing apoptosis in kudzu.

Therefore, a need exists for a method and system of creating a substance that can be applied to kudzu plants that will trigger the kudzu plant cells to go into programmed cell death, with the result being that the entire kudzu plant is eradicated.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information does not teach or render obvious, singly or when considered in combination, the inventor's claimed invention.

### BRIEF SUMMARY OF THE INVENTION

The general purpose of the present invention, which will be described subsequently in greater detail, is to provide a new kudzu eradication system which has many of the advantages of the eradication systems mentioned heretofore and many novel features that result in a new eradication system which is not anticipated, rendered obvious, suggested, or even implied by any of the prior art eradication systems, either alone or in any combination thereof.

One objective of the present invention is to provide a method for inducing apoptosis in kudzu.

Another objective of the present invention is to provide a method for isolating, extracting and synthesizing of a substance that will induce apoptosis in kudzu.

Another objective of the present invention is to provide a method for combining this substance with one or more substances for effective application to and absorption by the kudzu plant.

Another objective of the present invention is to provide a method for applying this combination of substances to kudzu in order that the cells in the root of the kudzu go into apoptosis.

The basis for the present invention is centered on the aspect of programmed cell death (PCD) in plant biology known as apoptosis and particularly the intrinsic pathway of apoptosis described above. One metabolic change for the kudzu plant occurs when the leaf and vine of the plant are repeatedly cut from the root until the root exhausts its nutritional storage and PCD is initiated.

The present invention is comprised of several steps. One step relates to apoptosis induction in kudzu from external stresses. Another step relates to resultant auto-generated phytotoxin isolation, extraction and analysis. Another step relates to foliar re-application of the discovered phytotoxin reformulated for systemic translocation throughout the kudzu plant, particularly to the main root.

The steps are highlighted as follows:
a. Apoptosis induction in kudzu from external stresses: It has been demonstrated that the kudzu plant can be killed by repeated and prolonged overgrazing or cutting. The plant lives until it eventually uses up the large store of starch reserves it has in its main root. After these reserves are gone, it then can no longer support the life processes and it dies. The first step is to induce apoptosis of kudzu in a controlled environment by repeated and prolonged cutting of the leaf and vine until the triggers are produced to initiate apoptosis.
b. Resultant auto-generated phytotoxin isolation, extraction, analysis and synthesis: The second step is to observe the root of the kudzu plant; to record the induction of apoptosis; to extract cells that are in the early stages of apoptosis, as well as pre-apoptosis and the final stage of apoptosis; to extract the relevant substances; to analyze and compare said substances; to isolate the triggers for apoptosis; to synthesize the isolated phytotoxin; to reformulate it with other substances as a systemic herbicide for foliar application and to determine the most effective herbicide application doses, frequency and concentrations through field research. Some of the ways that a cell in PCD can be identified is by nuclear chromatin condensation, nuclear shrinkage, ordered cleavage of the nuclear DNA, degradation of the prominent vacuole with release of hydrolytic enzymes, and the appearance of a demaged irregular plasma membrane.
c. Foliar re-application of the discovered phytotoxin reformulated for systemic translocation: The next step is to apply the herbicide to kudzu plants. Upon application the herbicide is absorbed by the leafy part of the plant and is conveyed to the root, where it induces apoptosis. Plant-related factors that influence herbicide effectiveness include retention, penetration, translocation, and metabolism. The above efforts account for any differential penetration and translocation. Differential metabolism, alteration of the herbicide within the plant, is the major reason for selectivity of most plant species. The active herbicidal ingredient produced by the method of the present invention, isolated and re-introduced in a reformulated compound, is not inactivated nor metabolically conjugated by kudzu because it is already found within the plant itself.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Further objects and advantages of the present invention will be apparent from the following detailed description of a presently preferred embodiment which is illustrated schematically in the accompanying drawings.

### BRIEF DESCRIPTION OF THE SEVERAL VIEWS OF THE DRAWING

Other advantages and features of the invention are described with reference to exemplary embodiments, which are intended to explain and not to limit the invention, and are illustrated in the drawings in which:

FIG. 1 is a flow chart showing the steps of the present invention.

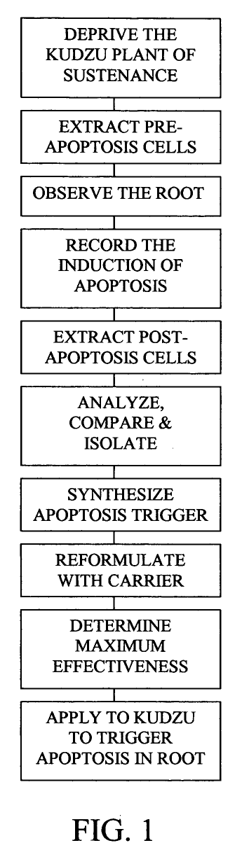

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

The preferred embodiment of the present invention is comprised of the following:
a. In a controlled environment, deprive the kudzu plant of sustenance through repeated and prolonged cutting.
b. Extract pre-apoptosis cells
c. Observe the root of the kudzu plant.
d. Record the induction of apoptosis.
e. Extract cells that are in the early stages of apoptosis, as well cells in the final stage of apoptosis; to extract the relevant substances.
f. Analyze said substances.
g. Compare said substances.
h. Isolate the triggers for apoptosis.
i. Synthesize the isolated phytotoxin.
j. Reformulate it with other substances as a systemic herbicide for foliar application.
k. Determine the most effective herbicide application doses, frequency and concentrations through field research.
l. Apply the systemic herbicide.

In the preferred embodiment, the systemic herbicide is comprised of an oil-based carrier since the more oil soluble an herbicide is the more likely it is to penetrate the outermost cuticle of the plant, dissolve into and through the cuticle and move rapidly into the plant through the process of simple diffusion. The more water-soluble the herbicide is the lower the rate of movement through the cuticle. In the preferred embodiment, the application of the systemic herbicide is timed for when the kudzu plant is undergoing the early stages of rapid growth (but not too young—¼ or less expanded leaves) when active and functional sucrose translocation will influence herbicide movement and distribution within the plant. It is at this time that the plant is most susceptible to symplastically translocated herbicides.

An alternate embodiment of the herbicide produced by this method is comprised of symplastically (phloem) translocated formulations, because they move to points of active growth or food storage accumulation throughout the entire plant including the root structures and leaves. An additional embodiment is comprised of nine molecule carbon chain non-ionic spreaders as an efficient adjuvant for herbicide efficacy. Since the ‘9-mol’ spreaders have the most neutral charge of the non-ionic spreaders, they are best suited for the penetration and translocation of herbicides.

1. A method of killing kudzu, comprising:
a. cutting the leaves and stems of the kudzu plant repeatedly;
b. extracting pre-apoptosis cells;
c. observing the root of the kudzu plant;
d. recording the induction of apoptosis;
e. extracting early-stage apoptosis cells;
f. extracting final-stage apoptosis cells;
g. extracting the relevant substances from said pre-apoptosis cells, said early-stage apoptosis cells and said final-stage apoptosis cells;
h. analyzing said substances;
i. comparing said substances;
j. isolating the triggers for apoptosis;
k. synthesizing the isolated phytotoxin;
l. reformulating it with a carrier as a systemic herbicide for foliar application;
m. determining the most effective herbicide application doses, frequency and concentrations through field research; and
n. applying the systemic herbicide.

2. The method of claim 1, wherein the carrier is comprised of an oil-based substance.

3. The method of claim 2, wherein the applying of the systemic herbicide is timed for when the kudzu plant is undergoing the early stages of rapid growth.

4. The method of claim 3, wherein Ca²⁺ is added to said phytotoxin.
